(19) United States
(12) Patent Application Publication
(10) Pub. No.: US 2016/0088143 A1
(43) Pub. Date: Mar. 24, 2016

(54) METHOD, SYSTEM AND APPARATUS FOR GRACEFUL DISCONNECTION FROM A WIRELESS DOCKING STATION

(71) Applicant: Intel IP Corporation, Santa Clara, CA (US)

(72) Inventors: Daniel Cohn, Raanana (IL); Eran Sudak, Herzliya (IL)

(73) Assignee: Intel Corporation, Santa Clara, CA (US)

(21) Appl. No.: 14/495,636

(22) Filed: Sep. 24, 2014

(51) Int. Cl. H04M 1/725; G06F 1/16

(52) U.S. Cl. CPC H04M 1/72527; G06F 1/1632

(57) ABSTRACT

The disclosed embodiments relate to method, system and apparatus for gracefully disconnecting from a wireless docking station. In one embodiment, the disclosure provides a method and system for proactively predicting an upcoming link loss caused by the mobile device's movement away from the wireless docking system. In an exemplary embodiment, data provided by the mobile device's accelerometer as well as signal quality data are used to indicate an upcoming link loss. Prior link loss patterns including accelerometer output and signal quality can be used to determine intentional link loss events. Once determination is made that the upcoming disconnection is intentional, steps may be taken to gracefully disconnect the mobile device from the docking station before the link loss occurs. The graceful disconnection may be implemented without requiring user intervention or incurring data loss.

### BACKGROUND

1. Field

The disclosure relates to a method, system and apparatus to gracefully disconnect a mobile device from a wireless docking station. Specifically, the disclosure relates to a method, system and apparatus to detect whether a mobile device is leaving an area serviced by a wireless docking station and to gracefully disconnect the mobile device without data loss and without user engagement.

2. Description of Related Art

Wireless docking systems are used to wirelessly connect a mobile device to a set of peripherals through a concentrator known as the docking station. Conventional peripherals include monitors, pointing devices (e.g., mice), tablets, mobile computing devices, keyboards, cameras and storage devices. The docking station wirelessly serves an area of interest. When entering the area supported by the docking station, each device may manually or automatically join a local network supported by the docking station.

When a mobile device leaves the area supported by the docking station without explicitly closing the wireless docking session, the wireless link will degrade and eventually disconnect the mobile device, thereby ending the wireless docking session. Under such conditions, the user-to-peripheral session will be terminated abruptly causing undesirable consequences. For example, if a storage device session is unexpectedly terminated during a file write operation, the file system metadata may not be adequately updated and the data may be corrupt. In some circumstances, the user may be asked to repair the disk during the subsequent session. In other circumstances, the data may be irretrievably lost.

A conventional solution is to require the user to manually terminate the wireless docking session and wait for confirmation before leaving the area supported by the docking station. The system would then gracefully terminate peripheral sessions before confirming termination. The conventional solution is inferior because it requires user initiation and can be time consuming.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 is a schematic representation of an environment for implementing an embodiment of the disclosure;

FIG. 2 schematically shows an area served by a wireless docking station;

FIG. 3 schematically illustrates an exemplary system for implementing an embodiment of the disclosure;

FIG. 4 is an exemplary learning process for a LAP Learning module; and

FIG. 5 shows an exemplary method for implementing an embodiment of the disclosure.

### DETAILED DESCRIPTION

The disclosed embodiments provide method, system and apparatus to predict and proactively manage an upcoming wireless link loss caused by a mobile device's departure from a docking station's service area. In one embodiment, data provided by the mobile device's accelerometer is used to identify user movement patterns that may indicate an upcoming intentional link loss. Once such pattern is identified, a graceful termination procedure is implemented before the actual link loss occurs. The disclosed embodiments support unmanaged disconnection (i.e., without requiring user intervention) while gracefully terminating mobile device's session with docking peripherals. The exemplary embodiments disclosed herein combine the robustness of manual undocking with the conveniences of automatic undocking which result in a superior user experience.

Certain embodiments may be used in conjunction with various devices and systems, for example, a mobile phone, a smartphone, a laptop computer, a sensor device, a Bluetooth (BT) device, an Ultrabook™, a notebook computer, a tablet computer, a handheld device, a Personal Digital Assistant (PDA) device, a handheld PDA device, an on board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AV) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Institute of Electrical and Electronics Engineers (IEEE) standards (IEEE 802.11-2012, IEEE Standard for Information technology-Telecommunications and information exchange between systems Local and metropolitan area networks—Specific requirements Part 11: Wireless LAN Medium Access Control (MAC) and Physical Layer (PHY) Specifications, Mar. 29, 2012; IEEE 802.11 task group ac (TGac) (“IEEE 802.11-09/0308r12—TGac Channel Model Addendum Document”); IEEE 802.11 task group ad (TGad) (IEEE 802.11ad-2012, IEEE Standard for Information Technology and brought to market under the WiGig brand—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band, 28 Dec. 2012)) and/or future versions and/or derivatives thereof, devices and/or networks operating in accordance with existing Wireless Fidelity (Wi-Fi) Alliance (WFA) Peer-to-Peer (P2P) specifications (Wi-Fi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, devices and/or networks operating in accordance with existing Wireless HD™ specifications and/or future versions and/or derivatives thereof, units and/or devices which are part of the above networks, and the like.

Some embodiments may be implemented in conjunction with the BT and/or Bluetooth low energy (BLE) standard. As briefly discussed, BT and BLE are wireless technology standard for exchanging data over short distances using short-wavelength UHF radio waves in the industrial, scientific and medical (ISM) radio bands (i.e., bands from 2400-2483.5 MHz). BT connects fixed and mobile devices by building personal area networks (PANs). Bluetooth uses frequency-hopping spread spectrum. The transmitted data are divided into packets and each packet is transmitted on one of the 79 designated BT channels. Each channel has a bandwidth of 1 MHz. A recently developed BT implementation, Bluetooth 4.0, uses 2 MHz spacing which allows for 40 channels.

Some embodiments may be used in conjunction with one way and/or two-way radio communication systems, a BT device, a BLE device, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like. Some demonstrative embodiments may be used in conjunction with a WLAN. Other embodiments may be used in conjunction with any other suitable wireless communication network, for example, a wireless area network, a “piconet”, a WPAN, a WVAN and the like.

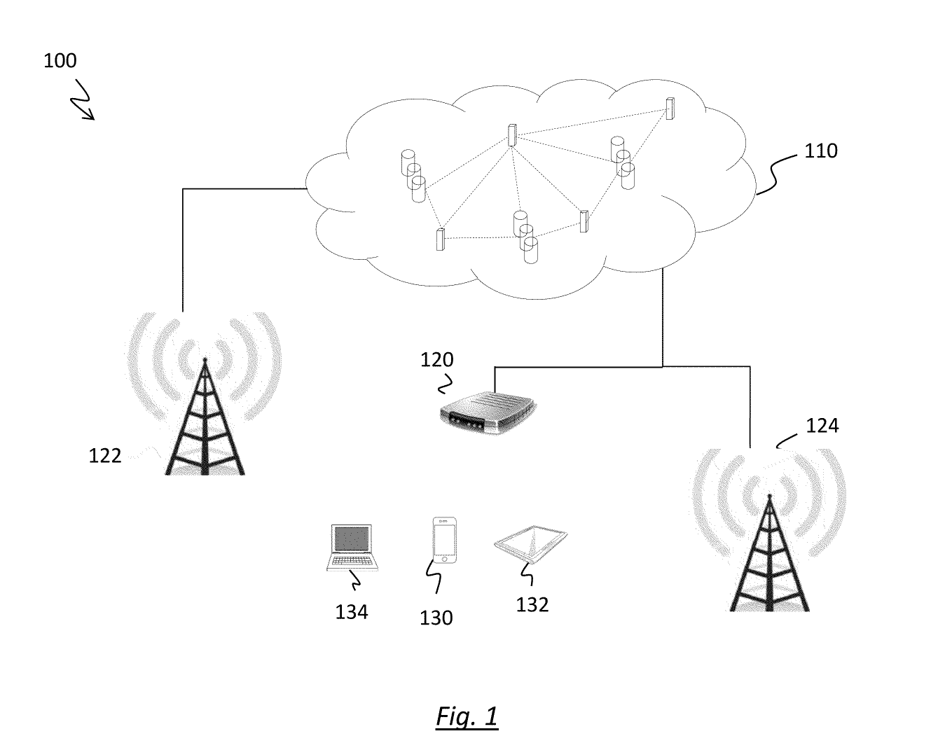

FIG. 1 schematically illustrates an efficient network for implementing an embodiment of the disclosure. Specifically, FIG. 1 shows network environment 100 having network 110 communicating with APs 120, 122 and 124. While FIG. 1 shows APs 120, 122 and 124 as part of network 110, the disclosed principles are not limited thereto and are equally applicable to environments where the AP is outside the network. Exemplary mobile stations (STAs) include smartphones, tablets, laptops or any other wireless device. STAs 130, 132, 134 and 136 may communicate with each other as well as with APs 120, 122 and 124. Each of APs 120, 122 and 124 may define a different WLAN and may comprise a modem, a router, a docking station or any other circuitry having a processor circuit in communication with a memory circuit adapted to compete for medium and deliver wireless access. It should be noted that a docking station may also be implemented as an 802.11 STA. The docking station may also be implemented as PBSS control point PCP under IEEE 802.11ad definition.

APs 120, 122 and 124 may compete with each other and with other devices for the medium. APs 120, 122a nd 124 as well as STAs 130, 132, 134 and 136 may continually transmit unsolicited data packets to other devices. One or more of the STAs 130, 132, 134 and 136 may comprise a BT or a BLE device. Such devices regularly transmit BLE broadcast signals. The signals contain BLE advertisement messages. BLE advertisement messages contain data. Other BLE devices continually scan for advertisement messages. The BLE advertisement messages enable interaction between BLE devices.

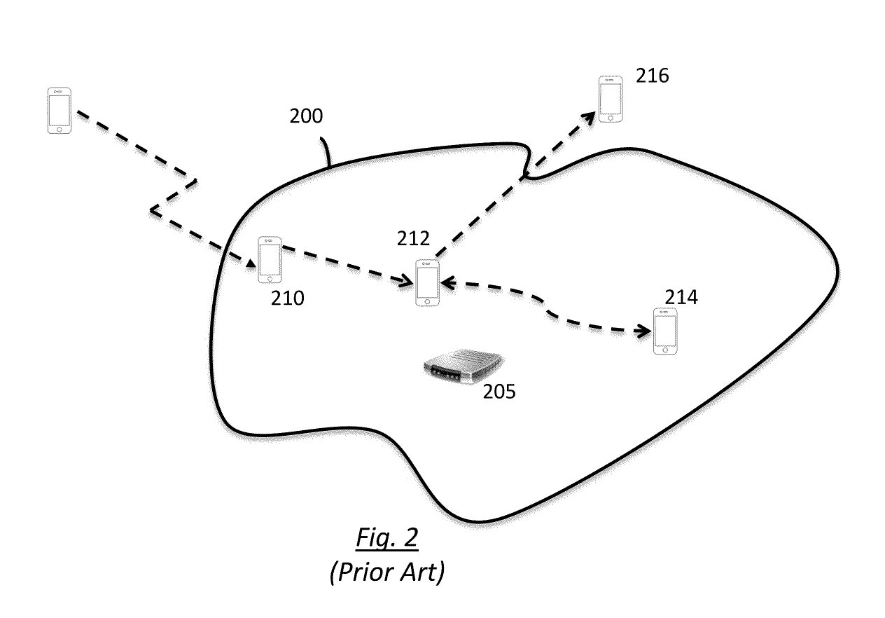

FIG. 2 schematically shows an area served by wireless docking station 205. The wireless docking station 205 may define a router, a wireless modem, a base station or any other device configured to wirelessly communicate with the mobile devices using any of the 802.11 protocols. FIG. 2 also shows a mobile device entering and exiting environment 200. The mobile device may remain stationary at location 210. The mobile device may also move about to locations 210, 212 and 214 of environment 200. The mobile device may exit environment 200 as shown by arrow 216. While within environment 200, the mobile device is served by the docking station 205 and is well within its radio signal reach. As will be discussed in greater detail below, the mobile device may include an accelerometer or a global positioning system (GPS) module to track its movement. As the mobile device moves away from docking station 205, the radio signal link may become weaker to the extent that the communication link between the mobile device and wireless docking station 205 may disconnect. In one embodiment of the disclosure metrics including physical movement and radio link viability are collected to identify an intentional link loss event when the mobile device exits environment 200.

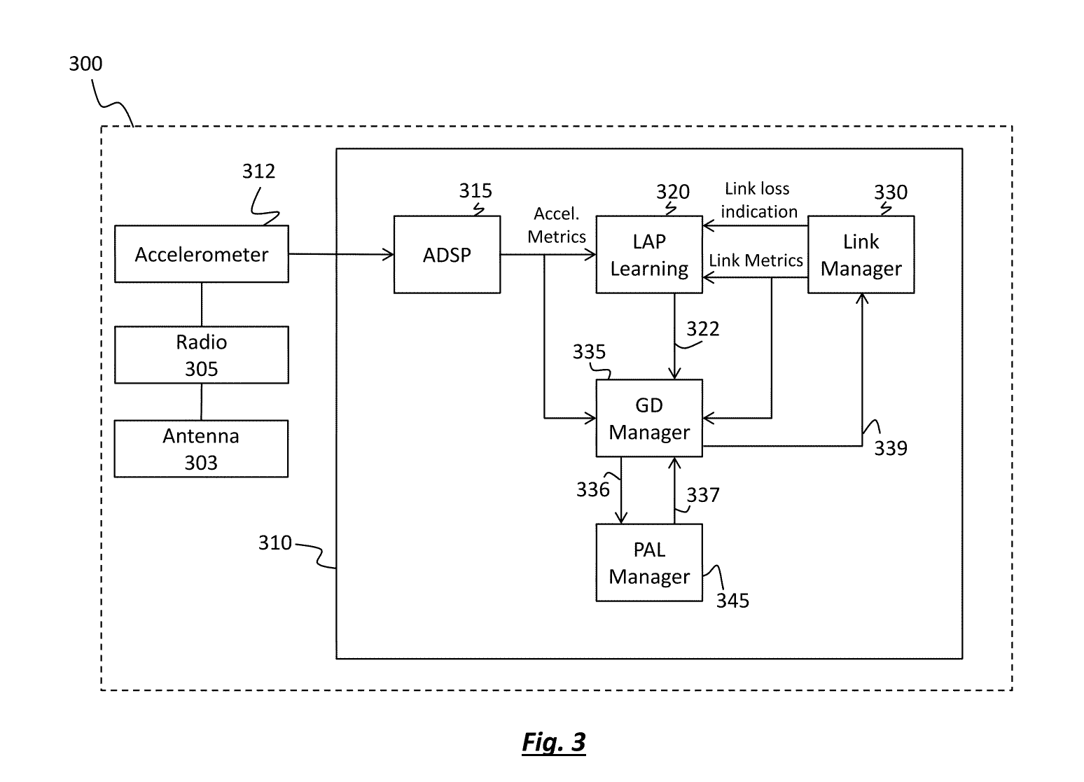

FIG. 3 schematically illustrates an exemplary system for implementing an embodiment of the disclosure. System 300 of FIG. 3 may be integrated with a mobile device. By way of example, FIG. 3 is shown with antenna(s) 303 and radio circuitry 305. Antennas 303 may comprise one or more antennas configured to receive different communication signals. Radio circuitry 305 may include circuitry to receive data symbols and transmit signals, or conversely, to signals and convert the signals into symbols for further processing. As stated, the mobile device may comprise a portable computer, a tablet or a smartphone. System 300 includes accelerometer 312 and wireless docking system 310. Accelerometer 312 may be integrated with the mobile device to report mobile device movement data. The movement data may include acceleration, velocity or coordinate changes associated with the mobile device. Accelerometers are conventionally used in smartphones, tablets and mobile computing devices. An accelerometer can measure acceleration (the rate of change in velocity) as well as changes in orientation. In certain applications, an accelerometer can detect orientation and direct the device to rotate the screen orientation.

System 300 also includes docking connector 310, which is implemented at the mobile device side of the wireless docking system. Docking connector 310 is responsible for connecting and disconnecting the mobile device to and from the wireless docking system. Docking connector 310 may be implemented as software, hardware or a combination of software and hardware (e.g., system on chip). Docking connector 310 includes acceleration data storage and processing (ADSP) module 315, Link and Acceleration Pattern (LAP) Learning module 320, Graceful Disconnect (GD) Manager module 335, Link Manager module 330 and PAL Manager module 345.

The ADSP module 315 receives acceleration data from accelerometer 312. The ADSP module may comprise an independent processor with instructions to receive and store output from accelerometer 312. ADSP module 315 may be programmed to calculate acceleration metrics, which can then be used by LAP learning 320 module. In one embodiment, ADSP module 315 continuously stores output from accelerometer 312 in a circular buffer such that the acceleration pattern in the latest period (T_{acc}) is always available. ADSP module 315 may calculate one or more of the metrics shown in Table 1 for the stored acceleration pattern. The metrics of Table 1 may be determined for multiple time intervals or time windows (T_{win}) in the [0, T_{acc}] range. The metrics shown at Table 1 are exemplary and non-exclusive.

TABLE 1
Exemplary Acceleration Metric Pattern

| Metric | |
|---|---|
| ID | Metric |
| 1 | Peak absolute acceleration (module of {x, y, z} vector |
| | components) |
| 2 | Peak absolute acceleration (module of {x, y} vector |
| | components) |
| 3 | Average absolute acceleration (module of {x, y, z} vector |
| | components) |
| 4 | Average absolute acceleration (module of {x, y} vector |
| | components) |
| 5 | Peak acceleration (module of {x, y, z} vector components) |
| | relative to long-term average |
| 6 | Peak acceleration (module of {x, y} vector components) |
| | relative to long-term average |
| 7 | Average acceleration (module of {x, y, z} vector components) |
| | relative to long-term average |
| 8 | Average acceleration (module of {x, y} vector components) |
| | relative to long-term average |
| 9 | Acceleration variance (module of {x, y, z} vector components) |
| 10 | Acceleration variance (module of {x, y} vector components) |

LAP learning module 320 may also be implemented on an independent processor circuitry or may be implemented by software. LAP Learning module 320 may be configured to learn link condition and acceleration patterns that are typically present before an intentional link loss event. Movement patterns and link conditions before intentional link loss vary across different users and work environment topologies. Consequently, such conditions can be learned for each user and each dock location. The inputs to LAP Learning module 320 include: acceleration metrics from ADSP 315, link condition metrics and link loss event indication from Link Manager 330. The link condition metrics may include: measured RSSI, measured Error Vector Magnitude (EVM) and an Estimated Carrier to Interference Plus Noise Ratio (CINR). Because a typical user does not detect very short intervals of unacceptable signal quality, the link loss event indication may be an event where the link quality is such that wireless docking quality is unacceptable for a period not longer than a minimum loss period (Tₘᵢₙₗₒₛₛ). LAP Learning module learns disconnect patters associated with a user and/or a wireless docking station and provides the identified pattern state, thresholds, interval and link metrics to GD Manager 335.

In an exemplary embodiment, Link manager 330 is an entity that resides across the OSI MAC and PHY layers. Link manager 330 monitors link metrics measured by the modem, which may include RSSI, Error Vector Magnitude (EVM), an Estimated Carrier to Interference Plus Noise Ratio (CINR) and MPDU error rate. The link manager uses this information to decide on transmission characteristics such as modulation and coding scheme or beam-forming vectors. In addition, the link manager is responsible for establishing and disconnecting a link as commanded by the management layer or, in the latter case, when the measured link metrics are not estimated to allow normal operation. For example, the link manager may decide to disconnect the link if the average CINR is lower than 3 dB, or if the average Media Access Control Data Unit (MPDU) error rate is greater than 1%.

GD Manager module 335 receives acceleration metrics from ADSP module 315 and link metrics from Link Manager module 330. GD Manager also receives 322 identified pattern state, threshold values, and interval and link metrics from LAP learning module 320. The information provided from LAP Learning module 320 (i.e., identified patterns) enable GD Manager 335 to compare incoming acceleration and link metrics with known patterns and determine whether a graceful disconnection is required.

If GD Manager 335 determines that a disconnection is imminent, it sends a disconnection command to PAL Manager module 345 as shown by arrow 336. The PAL manager adapts different protocols so the information can be transported over the wireless protocol. For example the PAL supports USB transported over Wi-Gig or DisplayPort (video data) transported over Wi-Gig.

PAL Manager 345 prepares the wireless device for gracefully disconnecting from docking station and sends a disconnect confirmation to GD Manager 335 as shown by arrow 337.

Upon receiving disconnection confirmation from PAL Manager 345, the GD Manager sends a disconnection command to Link Manager module 330 as shown by arrow 339. Thereafter, Link Manager module 330 disconnects the wireless link between system 300 (i.e., the mobile device) and the wireless docking station (now shown). The link manager disconnects the link only after receiving a confirmation from the PAL manager that the graceful disconnection has been completed. Link Manager 330 is a MAC/PHY entity. The PHY component measures PHY metrics such as RSSI/CINR. The MAC component measures MAC metrics such as MPDU error rate and is also in charge of link connection and/or disconnection message flows.

In one embodiment of the disclosure, LAP Learning module 320 monitors movement and signal strength activities of the mobile device to discern disconnection patterns associated with a mobile device (e.g., a user) at a wireless environment. Once a connection pattern is identified, it is sent to GD manager for future use. The LAP Learning module 320 has a two-state output: “Pattern Found” or “No Pattern Found”. Different users may exhibit different movement patterns. Identifying unique movement and associated signal loss behavior for a user enhances disconnection prediction. LAP learning module 320 identifies every link loss event and determines whether an acceleration (or movement) preceded the link loss event.

To determine whether there is a correlation between the mobile device movement and signal termination, the LAP Learning module 320 must classify link loss events as intentional or unintentional. An unintentional link loss event is an event where the link is restored to the same dock in the subsequent time period (Tᵣₑₛₜ). In contrast, an intentional link loss event is one in which the link is not restored within a predefined window of time. In one embodiment, LAP Learning module 320 monitors disconnected links for several time windows (T_{win}) to determine whether the connection is restored. In one embodiment, the time windows are of different length. If the connection is restored, then the LAP Learning module 320 will consider the disconnect to be unintentional.

A LAP may be defined as a function of: Aₜₕ acceleration metric threshold, T_{win} and Lₜₕ link metric threshold as shown in Equation (1):

LAP=f{Aₜₕ,T_{win},Lₜₕ} (1)

The Aₜₕ acceleration metric defines the acceleration or movement during time window, T_{win}. In one embodiment, the Aₜₕ acceleration metric is greater than 3 m/sec². In another embodiment, the Aₜₕ acceleration metric is about 2-5 m/sec². The link metric threshold, Lₜₕ, determines the signal condition below which a viable signal is unsustainable. The Lₜₕ link metric threshold may be determined empirically or may be a predefined value. In one embodiment, the Lₜₕ link metric threshold is about −80 dBm.

To enhance accuracy of LAP Learning module 320, false positive (FP) and false negative (FN) events may also be identified. A false positive event is one where the acceleration and link condition metrics predict an upcoming link loss event that never occurred. A false negative event is one where an intentional link loss event occurred but was not predicted by the metrics. A LAP requires the following conditions: (1) the false positive event ratio is less than α_{FP} (a threshold measure of the pattern's fidelity), and (2) a false negative event ratio is less than α_{FN}. The α_{FP} and α_{FN} metrics may be used to determine viability of a movement pattern. These metrics help assess whether a disconnect pattern associated with a movement is a true or a false event. These metrics help LAP learning module 320 discern appropriate disconnect patterns and advise GD Manager module 335 accordingly. False positive ratio is relative to total number of link loss predictions. False negative ratio is relative to total number of intentional link loss events.

In one implementation, a false positive event is detected by LAP Learning module 320 when the following conditions are met: (1) acceleration metric for T_{win} is above Aₜₕ (accelerating metric threshold (interchangeably, hit) which means the mobile device is accelerating faster than a threshold value determined to be correlated to intentional disconnect (i.e., the user is getting up to leave); (2) link metric is below Lₜₕ (link metric threshold), which means the signal strength data indicates a drop as compared to the threshold that was determined to correlate to a disconnection pattern; and (3) intentional link loss does not occur within T_{gd}+Tₜₒₗ, which means there was no intentional loss. T_{gd} is the time required for a graceful disconnection. T_{gd} is selected such that there will be enough time to complete the graceful disconnection process since the intentional loss pattern is identified until the link is lost. Tₜₒₗ is the tolerance margin time and defines the advanced timing required prior to disconnection. T_{gd} and Tₜₒₗ may be determined empirically. False positive events are unavoidable but they can be minimized by the learning process. In some instances when false positive events occur, they are undistinguishable from a real disconnection pattern so the device will be disconnected. When the false positive conditions are met, a false positive event is detected by LAP learning module 320. When a false positive condition is detected, GD Manager 335 will not disconnect the mobile device from docking station.

An object of the pattern recognition is to predict an intentional loss event that occurs ideally after the time required for a graceful disconnection (T_{gd}) such that graceful disconnection can be completed before the link loss event occurs. The disclosed embodiment can tolerate an earlier prediction where the link loss event occurs at a time after T_{gd}+Tₜₒₗ, where the graceful disconnection can still be completed in time while only the link may be terminated slightly earlier. However, if the link event is predicted less than T_{gd} before link loss occurs, graceful disconnection may not be completed before the link is lost.

In another embodiment, a false negative event is one where the following conditions are met: (1) intentional link loss occurs, and (2) the following conditions were not simultaneously true during the previous T_{gd}+Tₜₒₗ interval: (a) Acceleration metric for T_{win} is above Aₜₕ, or (b) the link metric is below Lₜₕ. It should be noted that the false negative ratio is relative to the total number of disconnection events. False negative events are missed upcoming disconnection and the device will disconnect without graceful disconnect procedure.

The LAP Learning module's state output is “pattern found” when the following criteria is met: (1) A LAP has been identified pursuant to the above criteria; (2) The number of monitored link loss events classified as intentional is higher than N_{I}, where N_{I} is an empirically determined threshold number of intentional link loss; and (3) The number of monitored link loss events and acceleration metric hits is higher than Nₕ, where Nₕ is an empirically determined threshold. Both the N_{I} and N_{H} conditions are used to ensure enough information has been collected. Otherwise, false positive/negative statistics are not relevant (e.g., if two link disconnection events out of two events are detected, there not enough data to say the LAP has found a reliable pattern.) If these conditions are not met, then the state output to GD Manager 335 is “no pattern found”.

The thresholds α_{FP}, α_{FN}, Nₕ and N_{I} may be configured so that P_{FN} and P_{FP} (the false negative and false positive probabilities of intentional loss detection) will be lower than a certain margin while keeping the learning process duration from being excessively long. These parameters may be selected based on empirical testing and may be further calibrated for the mobile device and/or the docking station. In one application of the disclosure, the confidence level of the metric is defined by Equation (2) as follows:

Confidence level=1−(<false positive ratio(α_{FP})>−<false negative ratio(α_{FN})>)/2 (2)

FP and FN are another metric for evaluating the accuracy of the prediction; that is, the likelihood of having false positive or false negative events. In one embodiment, N_{I} and N_{H} are selected at a high enough value such that P_{FN} and P_{FP} will be close enough to α_{FP} and α_{FN}.

In one implementation, the FP and FN likelihood values are calibrated empirically for best user experience. There may be a psychological component in determining how much users are bothered by false positives or false negatives. In one embodiment, the range may be in the low single-digit percentage value. An exemplary default value may be 1% for false positive and 5% false negative.

Graceful disconnection time (T_{gd}) is selected such that there will be enough time to complete the graceful disconnection process since the intentional loss pattern is identified until the communication link is lost. A tolerance margin (Tₜₒₗ) may be added to T_{GD} such to include additional error margin. The value for Tₜₒₗ maybe empirically determined. In one embodiment the Tₜₒₗ is about 1-3 sec.

In one embodiment, LAP Learning module 320 continues to monitor the metrics event after a LAP has been identified. The continued monitoring enables LAP Learning module 320 to: (1) replace the outstanding output state with a pattern with a higher confidence level (e.g., chose a tentative pattern and test to see whether it has a higher confidence level); or (2) declare a new state of “no pattern found” if the preexisting conditions are no longer valid. Learned LAPs and their associated parameters may be persistent (i.e., not detected when the mobile device restarts and may be associated to a specific docking station.

In one embodiment, the LAP Learning module 320 is configured with default LAPs to enable operation out-of-the box and before learning. Learning can refine the patterns and improve the prediction metrics. However, the user may choose to disengage the default patterns if default patters produce undesired results.

As stated, the GD Manager module 335 is responsible for triggering the graceful disconnection process when an upcoming intentional loss event is predicted. When the identified pattern state input is “no pattern identified” (i.e., the initial state), GD Manager 335 may be inactive. Otherwise, GD Manager module 335 monitors acceleration and link condition metrics inputs and when they cross their respective thresholds (above and below respectively) it issues a disconnection command 336 to PAL Manager module 345. PAL Manager module 345 sends disconnection confirmation 337 to GD Manager module 335 confirming that the peripheral disconnection process has been successfully completed. Thereafter, GD Manager module 335 issues a disconnection command to the Link Manager 330.

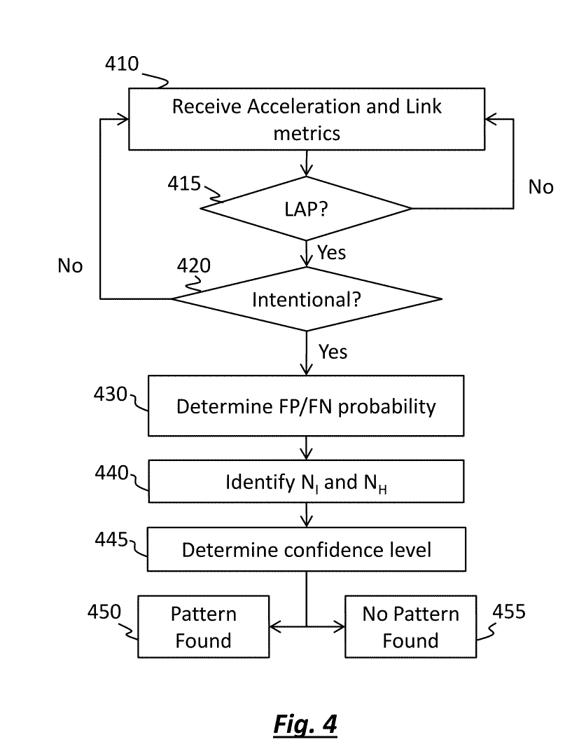

FIG. 4 is an exemplary learning process for the LAP Learning module. At step 410, the LAP Learning module receives acceleration metrics, Link loss indication and the Link metrics. The movement or acceleration metric can be obtained by an accelerometer associated with the mobile device. The movement may be in one, two or three dimensions. For example, movement may measure acceleration pattern of the mobile device in two-dimensional (XY) area. The link metrics may include data relating to the signal strength and quality between the mobile device and the docking station. The movement and link data can be received periodically and may report data averaged for a predefined period of time (T_{win}). In one embodiment, the value of T_{win} may be adjusted by the user. In another embodiment the device will try different windows (T_{win}) when looking for patterns.

At step 415, the LAP Learning module determines whether a LAP is detected. As discussed in relation to Equation (1), a LAP may be a triplet (Aₜₕ, T_{win} and Lₜₕ) that meets the following criteria: (1) false positive event ration is less than α_{FP}, and (2) the false negative event ratio is less than α_{Fn}. If a LAP is not detected, then the process reverts back to step 410. If a LAP is identified, the process continues to step 420 where determination is made as to whether the link loss was intentional or unintentional. An intentional link loss is one where the communication link is not restored after one or more consecutive T_{win} periods. If the link loss was not intentional and the link is subsequently restored, the process reverts back to step 410.

If the link loss was intentional, the process continues at step 430 where determination is made as to the likelihood of the LAP being a false positive or a false negative. In addition, a false positive ratio is determined relative to the total number of metrics threshold hits (Nₕ). A false negative ratio is relative to the total number of intentional disconnection events (N_{I}). At step 440 the value for Nₕ and N_{I} is determined. At step 445 confidence level is determined as described in relation to Equation (2).

In one embodiment, the device will try different LAPs when looking for patterns.

When the number of monitored link loss events classified as intentional is higher than N_{I}, the number of monitored link and acceleration metrics hits is higher than Nₕ and α_{fn} and α_{fp} are below their respective thresholds, then the algorithm output is pattern found as shown in step 450. Otherwise, the state output of the process is no pattern found as shown at step 455. In one embodiment, the pattern learning algorithm of FIG. 4 continues even when a pattern is found.

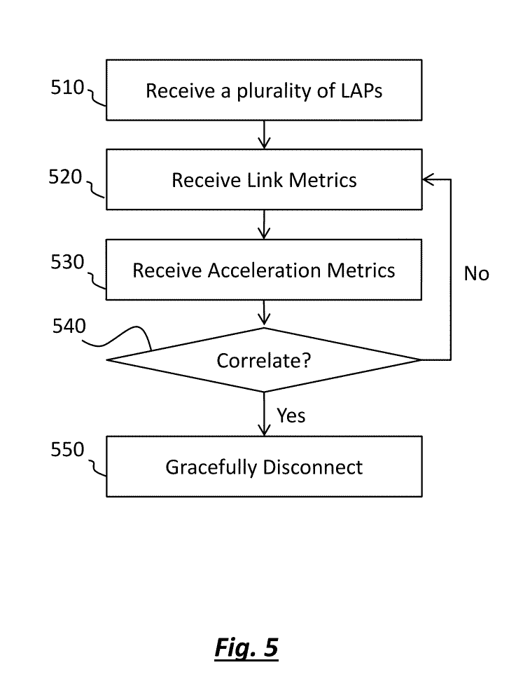

FIG. 5 shows an exemplary method for implementing an embodiment of the disclosure. Specifically, FIG. 5 shows an exemplary method for determining whether a communication link between a mobile device and a wireless docking station should be gracefully disconnected in anticipation of the mobile device's movement away from the service area. The process of FIG. 5 may be implemented at GD Manager module (see FIG. 3) or a processor circuitry in communication with a memory circuitry. The memory circuitry may be configured for long- or short-term memory retention.

The method of FIG. 5 starts at step 510 when a plurality of establish LAPs are received and stored at the memory circuit. At step 520 and 530, Link metrics and acceleration metrics are respectively received. The link metrics and acceleration metrics may comprise data for one or more communication time windows (T_{win}) and may depict movement of a mobile device within a wireless environment serviced by a docking station. Receiving link metrics and acceleration metric need not be in the order shown in steps 520 and 530. These metrics can arrive in any order or simultaneously without departing from the disclosed principles.

At step 540 the metric data is correlated with the plurality of LAPs. If the metric data correlates to an existing link and acceleration pattern associated with an intentional disconnect, then at step 550 a process is initiated to gracefully disconnect the mobile device from the wireless docking station. On the other hand, if no correlation is found, the process continues to steps 520 and the communication link is not disturbed.

The following examples pertain to various embodiments of the disclosure. Example 1 relates to a system to provide automated graceful disconnection of a mobile device from a wireless docking station, the system comprising: a first logic to receive acceleration metrics and link metrics for a mobile device and to identify a plurality of intentional link loss patterns between the mobile device and the wireless docking station; a second logic to receive link and acceleration metrics for the mobile device during a first interval, the second logic configured to correlate the received acceleration and link metrics for the first interval with the plurality of intentional link loss patterns to determine whether a disconnect is imminent; and a third logic to disconnect the communication link between the mobile device and the docking station.

Example 2 relates to the system of example 1, further comprising a fourth logic to gracefully disconnect the mobile device from the docking station when the second logic provides a disconnection command, the fourth logic to send a disconnect confirmation to the third logic.

Example 3 relates to the system of example 1, wherein the first logic is further configured to receive acceleration metrics and link metrics for the mobile device during a plurality of time windows and to identify a plurality of intentional link loss patterns for each time window.

Example 4 relates to the system of example 1, wherein the first logic is further configured to determine an intentional disconnect pattern when the acceleration metrics and the link metrics for a time interval indicate an intention to disconnect the mobile device from the docking station without reconnecting during a subsequent time interval.

Example 5 relates to the system of example 1, wherein the first logic is further configured to identify an intentional disconnect event when a wireless link is not restored within a predefined time window (Tᵣₑₛₜ).

Example 6 relates to the system of example 5, wherein the first logic is further configured to identify a false negative event after the intentional link loss event occurs and where neither acceleration metric is above a known acceleration metric threshold (Aₜₕ) nor the link metric is below a known link metric threshold (Lₜₕ).

Example 7 relates to the system of example 3, wherein the first logic identifies a false negative pattern to the second logic.

Example 8 relates to a tangible machine-readable non-transitory storage medium that contains instructions, which when executed by one or more processors result in performing operations comprising: receive a plurality of movement patterns associated with disconnecting a mobile device from a docking station; measure one or more link metrics and acceleration metrics associated with the movement of the mobile device in the wireless environment during a first interval; correlate the plurality of movement patterns with the link and acceleration metrics of the first interval to determine whether to initiate a graceful disconnect of the mobile device from the docking station; and gracefully disconnect the mobile device from the wireless docking station when the link metrics and acceleration metric correlate to one of the plurality of movement patters associated with an intentional disconnect event.

Example 9 relates to the tangible machine-readable non-transitory storage medium of example 8, wherein the operation further cause the one or more processors to disconnect the mobile device in real-time and without user engagement.

Example 10 relates to the tangible machine-readable non-transitory storage medium of example 8, wherein the operations further cause the one or more processors to direct a module to terminate a communication link between the mobile device and the wireless docking station.

Example 11 relates to the tangible machine-readable non-transitory storage medium of example 8, wherein an intentional disconnect event defines a known movement pattern having a continual recession in link metrics over time.

Example 12 relates to the tangible machine-readable non-transitory storage medium of example 8, wherein the operations further cause the one or more processors to correlate patterns with the link metrics and the acceleration metrics of a second interval to determine whether to initiate a graceful disconnection.

Example 13 relates to the tangible machine-readable non-transitory storage medium of example 12, wherein the operations further cause the one or more processors to store the link metrics and the acceleration metrics associated with one of the first interval or the second interval when one of the first interval or the second interval is followed by disconnecting the mobile device from the wireless docking station.

Example 14 relates to a method to gracefully disconnect a mobile device from a wireless docking station, the method comprising: receiving, at a processor, a plurality of link and acceleration patterns (LAPs) associated with intentionally disconnecting the mobile device from the docking station; measuring one or more link metrics associated with the movement of the mobile device in the wireless environment during a first interval; measuring one or more acceleration metrics associated with the movement of the mobile device in the wireless environment during the first interval; correlating the LAPs with the link and the acceleration metrics of the first interval to determine whether to initiate a graceful disconnection; and gracefully disconnecting the mobile device from the wireless docking station when the link metrics and acceleration metric correlate to one of the LAPs associated with an intentional disconnect event.

Example 15 relates to the method of example 14, wherein the step of gracefully disconnecting the mobile device further comprises disconnecting the mobile device in real time and without user engagement.

Example 16 relates to the method of example 14, wherein the step of gracefully disconnecting the mobile device further comprises terminating a communication link between the mobile device and the wireless docking station.

Example 17 relates to the method of example 14, wherein an intentional disconnect event defines a known movement pattern having a continual recession in link metrics over a time interval.

Example 18 relates to the method of example 14, wherein the step of correlating the plurality of movement patterns further comprises correlating patterns with the link and the acceleration metrics of a second interval to determine whether to initiate a graceful disconnection.

Example 19 relates to the method of example 18, further comprising storing the link metrics and the acceleration metrics associated with one of the first interval or the second interval when one of the first interval or the second interval is followed by an event disconnecting the mobile device from the wireless docking station.

Example 20 relates to the method of example 14, wherein the plurality of link and acceleration patterns (LAPs) are default LAPs associated with intentionally disconnecting a first mobile device from a first docking station.

While the principles of the disclosure have been illustrated in relation to the exemplary embodiments shown herein, the principles of the disclosure are not limited thereto and include any modification, variation or permutation thereof.

What is claimed is:

1. A system to provide automated graceful disconnection of a mobile device from a wireless docking station, the system comprising:
a first logic to receive acceleration metrics and link metrics for a mobile device and to identify a plurality of intentional link loss patterns between the mobile device and the wireless docking station;
a second logic to receive link and acceleration metrics for the mobile device during a first interval, the second logic configured to correlate the received acceleration and link metrics for the first interval with the plurality of intentional link loss patterns to determine whether a disconnect is imminent; and
a third logic to disconnect the communication link between the mobile device and the docking station.

2. The system of claim 1, further comprising a fourth logic to gracefully disconnect the mobile device from the docking station when the second logic provides a disconnection command, the fourth logic to send a disconnect confirmation to the third logic.

3. The system of claim 1, wherein the first logic is further configured to receive acceleration metrics and link metrics for the mobile device during a plurality of time windows and to identify a plurality of intentional link loss patterns for each time window.

4. The system of claim 1, wherein the first logic is further configured to determine an intentional disconnect pattern when the acceleration metrics and the link metrics for a time interval indicate an intention to disconnect the mobile device from the docking station without reconnecting during a subsequent time interval.

5. The system of claim 1, wherein the first logic is further configured to identify an intentional disconnect event when a wireless link is not restored within a predefined time window (Tᵣₑₛₜ).

6. The system of claim 5, wherein the first logic is further configured to identify a false negative event after the intentional link loss event occurs and where neither acceleration metric is above a known acceleration metric threshold (Aₜₕ) nor the link metric is below a known link metric threshold (Lₜₕ).

7. The system of claim 3, wherein the first logic identifies a false negative pattern to the second logic.

8. A tangible machine-readable non-transitory storage medium that contains instructions, which when executed by one or more processors result in performing operations comprising:
receive a plurality of movement patterns associated with disconnecting a mobile device from a docking station;
measure one or more link metrics and acceleration metrics associated with the movement of the mobile device in the wireless environment during a first interval;
correlate the plurality of movement patterns with the link and acceleration metrics of the first interval to determine whether to initiate a graceful disconnect of the mobile device from the docking station; and
gracefully disconnect the mobile device from the wireless docking station when the link metrics and acceleration metric correlate to one of the plurality of movement patters associated with an intentional disconnect event.

9. The tangible machine-readable non-transitory storage medium of claim 8, wherein the operations further cause the one or more processors to disconnect the mobile device in real-time and without user engagement.

10. The tangible machine-readable non-transitory storage medium of claim 8, wherein the operations further cause the one or more processors to direct a module to terminate a communication link between the mobile device and the wireless docking station.

11. The tangible machine-readable non-transitory storage medium of claim 8, wherein an intentional disconnect event defines a known movement pattern having a continual recession in link metrics over time.

12. The tangible machine-readable non-transitory storage medium of claim 8, wherein the operations further cause the one or more processors to correlate patterns with the link metrics and the acceleration metrics of a second interval to determine whether to initiate a graceful disconnection.

13. The tangible machine-readable non-transitory storage medium of claim 12, wherein the operations further cause the one or more processors to store the link metrics and the acceleration metrics associated with one of the first interval or the second interval when one of the first interval or the second interval is followed by disconnecting the mobile device from the wireless docking station.

14. A method to gracefully disconnect a mobile device from a wireless docking station, the method comprising:
receiving, at a processor, a plurality of link and acceleration patterns (LAPs) associated with intentionally disconnecting the mobile device from the docking station;
measuring one or more link metrics associated with the movement of the mobile device in the wireless environment during a first interval;
measuring one or more acceleration metrics associated with the movement of the mobile device in the wireless environment during the first interval;
correlating the LAPs with the link and the acceleration metrics of the first interval to determine whether to initiate a graceful disconnection; and
gracefully disconnecting the mobile device from the wireless docking station when the link metrics and acceleration metric correlate to one of the LAPs associated with an intentional disconnect event.

15. The method of claim 14, wherein the step of gracefully disconnecting the mobile device further comprises disconnecting the mobile device in real time and without user engagement.

16. The method of claim 14, wherein the step of gracefully disconnecting the mobile device further comprises terminating a communication link between the mobile device and the wireless docking station.

17. The method of claim 14, wherein an intentional disconnect event defines a known movement pattern having a continual recession in link metrics over a time interval.

18. The method of claim 14, wherein the step of correlating the plurality of movement patterns further comprises correlating patterns with the link and the acceleration metrics of a second interval to determine whether to initiate a graceful disconnection.

19. The method of claim 18, further comprising storing the link metrics and the acceleration metrics associated with one of the first interval or the second interval when one of the first interval or the second interval is followed by an event disconnecting the mobile device from the wireless docking station.

20. The method of claim 14, wherein the plurality of link and acceleration patterns (LAPs) are default LAPs associated with intentionally disconnecting a first mobile device from a first docking station.
